(19) United States
(12) Patent Application Publication
(10) Pub. No.: US 2022/0075804 A1
(43) Pub. Date: Mar. 10, 2022

(54) METHOD AND DEVICE FOR PROVIDING GUIDE INFORMATION FOR ENHANCEMENT OF ARTIST'S REPUTATION

(71) Applicant: Lighters Company Co., LTD., Incheon (KR)

(72) Inventor: Hami KIM, Seoul (KR)

(73) Assignee: Lighters Company Co., LTD., Incheon (KR)

(21) Appl. No.: 17/468,551

(22) Filed: Sep. 7, 2021

(30) Foreign Application Priority Data
Sep. 8, 2020 (KR) 10-2020-0114259

(51) Int. Cl. G06F 16/28; G06F 40/279; G06K 9/00; G06K 9/62

(52) U.S. Cl. CPC G06F 16/285; G06K 9/628; G06K 9/00248; G06F 40/279

(57) ABSTRACT

Disclosed is a method and device for providing guide information for enhancement of an artist's reputation. According to an embodiment of the inventive concept, guide information that may help to positively form an artist's reputation in an artist's main field or a field in which the artist intends to break new ground is provided. Thereby, it is possible to reduce the cost and time required for the artist or the artist's agency to positively form the artist's reputation by providing guide information.

### CROSS-REFERENCE TO RELATED APPLICATIONS

A claim for priority under 35 U.S.C. § 119 is made to Korean Patent Application No. 10-2020-0114259 filed on Sep. 8, 2020 in the Korean Intellectual Property Office, the entire contents of which are hereby incorporated by reference.

### BACKGROUND

Embodiments of the inventive concept described herein relate to a method and device for providing guide information for improving the reputation of an artist.

Artists, such as singers, actors, models, and broadcasters, are exposed to the public through various media, and the reputation of a certain artist is determined by the artist's images delivered to the public through media rather than the real life of the artist.

In addition, the artist's reputation determined in this way has a great influence on the success of the artist's activities. Therefore, for the success of the activity, the artist or the artist's agency puts a lot of effort to form a reputation that positively influences the activity.

However, once a certain reputation of an artist is formed in the public, a lot of time and money may be taken to change the reputation. Therefore, when a negative reputation for an artist is formed in the public, a lot of time and money may be incurred to change the negative reputation into a positive reputation.

Also, artists do not only work in their main field, but often advance into various fields. However, when there is a gap between the field an artist wants to advance into and the artist's main field, a lot of time and money will be taken to build a positive reputation in the field an artist wants to advance into.

For example, when an idol singer debuts as an actor and works, there may be formed a negative reputation that the idol singer will not be able to perform his/her acting.

Therefore, there is a need for a method that can help to positively form an artist's reputation in various fields, thereby reducing the time and cost of the artist and the agency.

### SUMMARY

Embodiments of the inventive concept provide a method and device for providing guide information for improvement of an artist's reputation to solve the above-described problems.

Embodiments of the inventive concept provide a method and device for providing guide information for improvement of an artist's reputation, which provide guide information capable of helping to positively form the artist's reputation in the artist's main field or a new field the artist wants to advance into.

Embodiments of the inventive concept provide a method and device for providing guide information for improvement of an artist's reputation, which reduces the cost and time used by the artist or the artist's agency to positively form the artist's reputation by providing guide information.

However, problems to be solved by the inventive concept are may not be limited to the above-described problems. Although not described herein, other problems to be solved by the inventive concept can be clearly understood by those skilled in the art from the following description.

According to an embodiment, a guide information providing device for improvement of an artist's reputation includes an artist data collection module that collects artist data including at least one of a text, a video, and an image as data obtained by searching for an artist, an artist analysis module that groups the artist data by a plurality of different fields, classify the artist data into a plurality of pieces of group data, and analyzes awareness and reputation using each of the pieces of group data, a matching element analysis module that classifies an appearance type and a personality type using the artist data, a top artist determining module that determines at least one top artist having a higher value than a preset reference artist, with respect to the awareness and the reputation associated with at least one of the pieces of group data, a comparative artist determining module that specifies any one of the top artists as a comparative artist, or specifies an artist having an appearance type and a personality type matching those of the reference artist as the comparative artist, an artist activity analysis module that analyzes activity data on the artist using the artist data, and a comparative data providing module that derives comparative data using the activity data of the reference artist and the comparative artist, and provides the comparative data to a user.

Further, each of the pieces of group data includes a preset keyword group for each field.

Further, the artist analysis module may include a field-based grouping unit that classifies the artist data including the preset keyword group into the group data corresponding to the preset keyword group, a weight determining unit that calculates a weight for the artist data by analyzing an exposure frequency of the artist data, an awareness analysis unit that calculates an awareness for each of the pieces of group data by summing up all weights of pieces of artist data included in each of the group data, and a reputation analysis unit that calculates the reputation for each of the pieces of group data using positive words, negative words, and weights of the artist data included in each of the group data.

Further, the reputation for each of the group data may be calculated by calculating text reputations for the pieces of artist data in a manner to subtract a number of the negative words from a number of the positive words and multiply a result of the subtraction and the weight for each of the pieces of artist data and then summing up all the text reputations included in the group data.

Further, the appearance type may include a preset face type and a preset body proportion type, and the personality type may include an MBTI type or a preset standard personality type.

Further, the matching element analysis module may include an appearance analysis unit that determines the face type by using a forehead length, a nose length, an eye length and width, a lip length, a lower jaw proportion and determine the body proportion type using lengths of body parts and a proportion of the body parts, and a personality analysis unit that determines the MBTI type or the standard personality type.

Further, the top artist determining module may include the reference artist determining unit that determines a reference artist, a comparative group determining unit that determines comparative group data that is data to be compared among the plurality of pieces of group data, and a top artist determining unit that determines at least one top artist having a higher value than the preset reference artist, with respect to the awareness and reputation associated with the comparative group data.

Further, the comparative artist determining module may include a specified comparative artist determining unit that determines any one of the top artists as a comparative artist and a recommended artist determining unit that determines an artist having an appearance type and a personality type matching those of the reference artist among the top artists as the comparative artist.

Further, the artist data may include artist SNS data obtained by searching for an artist's SNS, fashion data including the artist's reputation, hobby data including a hobby keyword included in a preset hobby keyword group, job activity data including a job activity keyword included in a preset job activity keyword group, and external activity data including an external activity keyword included in a preset external activity keyword group.

Further, the artist activity analysis module may include an SNS keyword analysis unit that analyzes an SNS keyword that is an overlapping keyword by using the artist SNS data, an SNS reputation analysis unit that calculates SNS reputation by using the artist SNS data, a fashion analysis unit that analyzes fashion type information that is information including a clothing type, products, and brands mainly worn by the artist by using the fashion data, a fashion reputation analysis unit that calculates fashion reputation by using the fashion data, a hobby analysis unit that analyzes hobby data that is information on a most overlapping keyword among the hobby keywords included in the hobby data, a hobby reputation analysis unit that calculates hobby reputation by using the hobby data, a job activity awareness analysis unit that calculates job activity awareness by summing up weights of the job activity data, and an external activity awareness analysis unit that calculates external activity awareness by summing up weights of the external activity data.

Further, the activity data may include the SNS keyword, the SNS reputation, the fashion type information, the fashion reputation, the hobby data, the hobby reputation, the job activity awareness, and the external activity awareness.

Further, the comparative data providing module may receive activity data of the reference artist and activity data of the comparative artist, and match the reference artist and the comparative artist with respect to the SNS keyword, the SNS reputation, the fashion type information, the fashion reputation, the hobby data, the hobby reputation, the job activity awareness, and the external activity awareness and provide a result of the matching to the user.

According to an embodiment, a guide information providing method for improvement of an artist's reputation includes collecting, by an artist data collection module of the device, artist data including at least one of a text, a video, and an image as data obtained by searching for an artist, grouping, by an artist analysis module of the device, the artist data by a plurality of different fields, classify the artist data into a plurality of pieces of group data, and analyze awareness and reputation using each of the pieces of group data, classifying, by a matching element analysis module of the device, an appearance type and a personality type using the artist data, determining, by a top artist determining module of the device, at least one top artist having a higher value than a preset reference artist, with respect to the awareness and the reputation associated with at least one of the pieces of group data, specifying, by a comparative artist determining module of the device, any one of the top artists as a comparative artist, or specify an artist having an appearance type and a personality type matching those of the reference artist as the comparative artist, analyzing, by an artist activity analysis module of the device, activity data on the artist using the artist data, and deriving, by a comparative data providing module of the device, comparative data using the activity data of the reference artist and the comparative artist, and provide the comparative data to a user.

Other specific details of the inventive concept are included in the detailed description and drawings

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating the configurations of a guide information providing system according to an embodiment of the inventive concept;

FIG. 2 is a block diagram illustrating a configuration of a comparative artist determining unit according to FIG. 1;

FIG. 3 is a diagram for describing classification criteria of group data;

FIG. 4 is a diagram for describing calculation criteria for awareness and reputation of group data;

FIG. 5 is a block diagram illustrating a configuration of a guide data providing unit according to FIG. 1;

FIG. 6 is a diagram for describing a classification process of the artist data classification module according to FIG. 5;

FIG. 7 is a flowchart of a specific process for operating a guide information providing system according to an embodiment of the inventive concept;

FIG. 8 is a diagram illustrating a detailed flow of S50 according to FIG. 7; and

FIG. 9 is a diagram illustrating a detailed flow of S60 according to FIG. 7.

### DETAILED DESCRIPTION

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated elements, but do not preclude the presence or addition of elements. Like reference numerals refer to like elements throughout the specification, and “and/or” includes each and all combinations of one or more of the mentioned elements. Although “first”, “second”, and the like are used to describe various components, these components are of course not limited by these terms. These terms are only used to distinguish one component from another. Thus, a first element discussed below could be termed a second element without departing from the teachings of the inventive concept

Unless otherwise defined, all terms (including technical and scientific terms) used herein have the same meaning as commonly understood by one of ordinary skill in the art to which this invention belongs. It will be further understood that terms such as those defined in commonly used dictionaries, will not be interpreted in an idealized or overly formal sense unless expressly so defined herein..

The term “electrically” as used below means that one component is electrically or mutually communicatively connected to another component.

Hereinafter, embodiments of the present disclosure will be described with reference to the accompanying drawings.

Description of a guide information providing system for enhancement of an artist's reputation according to an embodiment of the inventive concept.

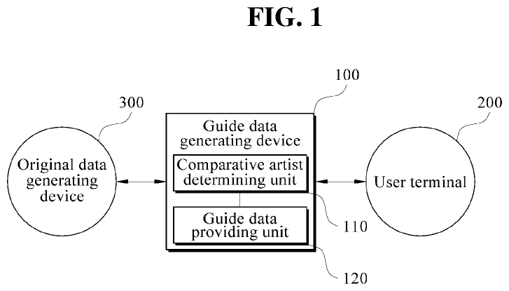

FIG. 1 illustrates components of a guide information providing system for enhancement of an artist's reputation according to an embodiment of the inventive concept. For easy of description, the term “a guide information providing system” used below may be understood to refer to “a guide information providing system for enhancement of an artist's reputation”.

The guide information providing system according to the present embodiment may include a guide data generating device 100, a user terminal 200, and an original data generating device 300.

The original data generating device 300 may collect artist data 1 including information about an artist. The collected artist data 1 may be transmitted to the guide data generating device 100.

To this end, the original data generating device 300 and the guide data generating device 100 may be connected to each other to facilitate information communication.

In an embodiment, the artist data 1 may be collected by a web crawling method. The artist data 1 may be information collected about a plurality of different artists. That is, the artist data 1 may include a plurality of pieces of artist data, and each piece of artist data 1a may include information about a specific artist.

For example, when attempting to collect artist data 1a about an artist named X1, the original data generating device 300 may collect artist data 1a including a keyword “X1”.

The artist data 1a may include at least one of text, an image, and a video. For example, the artist data 1a may be data collected from articles, social network services (SNS), blogs, or the like.

The guide data generating device 100 may generate guide data using the artist data 1 received from the original data generating device 300.

The guide data may include a result of comparison between a specific artist functioning as a reference and an artist to be compared. A process for deriving guide data will be described in detail later.

The generated guide data may be transmitted to the user terminal 200. To this end, the user terminal 200 and the guide data generating device 100 may be electrically connected to each other.

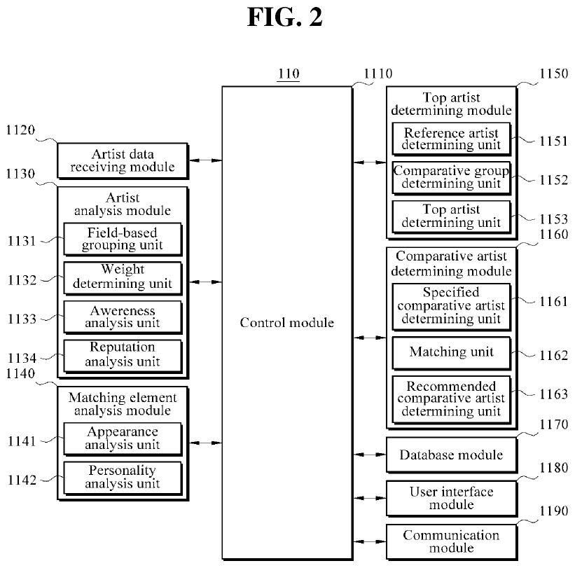

The user terminal 200 may transmit information about a specific artist functioning as a reference or information about an artist to be compared to the guide data generating device 100. Hereinafter, the guide data generating device 100 will be described in detail with reference to FIGS. 2 to 6.

In one embodiment, the guide data generating device 100 may be one of electronic devices, such as a computer, a UMPC (Ultra Mobile PC), a workstation, a net-book (net-book), a PDA (Personal Digital Assistants), a portable (portable) computer, a web tablet (web tablet), a wireless phone, a mobile phone, a smart phone, and a portable multimedia player (PMP).

The guide data generating device 100 may include a comparative artist determining unit 110 and a guide data providing unit 120.

Description of the comparative artist determining unit 110

Referring to FIG. 2, the comparative artist determining unit 110 may include a control module 1110, an artist data receiving module 1120, an artist analysis module 1130, a matching element analysis module 1140, a top artist determining module 1150, a comparative artist determining module 1160, a database module 1170, a user interface module 1180, and a communication module 1190.

Various entities included in the comparative artist determining unit 110 may be electrically connected to each other. For example, communication between the entities may be performed through wired/wireless networks (not shown). For the wired/wireless networks, standard communication technologies and/or protocols may be used.

The hardware configuration of the comparative artist determining unit 110 may be implemented in various ways. For example, the artist data receiving module 1120 and the artist analysis module 1130 may be integrated into a single component. However, the inventive concept is not limited thereto, and may be implemented in various methods and combinations.

The control module 1110 may control the artist data receiving module 1120, the artist analysis module 1130, the matching element analysis module 1140, the top artist determining module 1150, the comparative artist determining module 1160, the database module 1170, the user interface module 1180, and the communication module 1190 to perform various functions of the comparative artist determining unit 110.

In one embodiment, the control module 1110 may also be called a processor, a controller, a microcontroller, a microprocessor, a microcomputer, or the like, and the control module 1110 may be implemented by hardware or firmware, software, or a combination thereof.

First, the artist data receiving module 1120 will be described.

The artist data receiving module 1120 may receive the artist data 1 collected by the original data generating device 300.

Also, the artist data receiving module 1120 may classify the artist data 1 collected for a plurality of artists into artist data 1a for each artist. Each artist data 1a classified by the artist data receiving module 1120 may be stored in the database module 1170.

For example, the artist data receiving module 1120 may divide the artist data 1 into artist data 1a for an artist named X1 and artist data 1a for an artist named X2.

The each artist data 1a classified may be transmitted to the artist analysis module 1130.

The artist analysis module 1130 may receive the artist data 1a, classify the artist data 1a into group data 2 for each field, and then analyze the awareness and reputation for the group data 2 for each field.

To this end, the artist analysis module 1130 may include a field-based grouping unit 1131, a weight determining unit 1132, an awareness analysis unit 1133, and a reputation analysis unit 1134.

The field-based grouping unit 1131 may classify each artist data 1a into field group data 2.

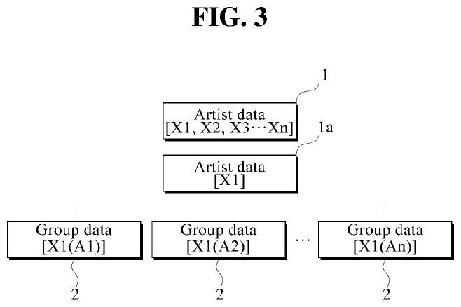

Referring to FIG. 3, a process in which the group data 2 is divided by the field-based grouping unit 1131 is illustrated.

In the illustrated embodiment, the artist data 1a collected for the artist X1 may be transmitted to the field-based grouping unit 1131.

The field-based grouping unit 1131 may classify the transmitted artist data 1a into a plurality of pieces of field group data 2.

In an embodiment, the transmitted artist data 1a may be subdivided into a plurality of fields A1, A2, A3 . . . An. For example, the fields in which the artist named X1 works may be classified into a singer, a model, an actor, and an entertainer.

Furthermore, the singer field may be classified into sub-fields such as ballad singers, hip-hop singers, RnB singers, and rock singers. In addition, the actor field may be classified in sub-fields such as melodrama, historical drama, comedy, and action.

In this case, the classified sub-fields may be classified into fields A1 to An. For example, it is possible to set a ballad singer to a field A1, a hip-hop singer to a field A2, and an RnB singer to a field A3.

A keyword group that may belong to each sub-field may be set in advance, and artist data 1a including keywords of the corresponding keyword group may be classified into a sub-field corresponding thereto.

In the illustrated embodiment, group data [X1(A1)] of the group data 2 may refer to a set of pieces of sub-field artist data classified into a ballad singer A1 field among the artist data 1a for the artist X1.

In one embodiment, the keyword group {a11, a12, a13, . . . a1n} included in the ballad singer A1 may be set and then the artist data 1a having a keyword included in {a11, a12, a13, . . . a1n} among the artist data 1a may be classified into the group data [X1(A1)].

In one embodiment, the keyword group {a21, a22, a23, . . . a2n} included in the hip-hop singer A2 may be set and then the artist data 1a having a keyword included in {a21, a22, a23, . . . a2n} may be classified into group data [X1(A2)].

That is, each sub-field may include the artist data 1a having keywords included in a keyword group provided in each sub-field.

In an embodiment not shown, the artist data 1a including an image or video may be classified into group data 2 by a machine learning algorithm. For example, by training a separate learning device on correlations between the artist's reputation or video and the sub-field and then setting classification criteria for each sub-field, the artist data 1a including an image or video may be classified into group data 2 according to the classification criteria for each sub-field.

Referring back to FIG. 2, before analyzing the awareness and reputation of each group data 2, a weight of the artist data 1a may be determined by the weight determining unit 1132.

The weight determining unit 1132 may receive the artist data 1a from the artist data receiving module 1120 and calculate a weight for the received artist data 1a.

In an embodiment, the weight for the artist data 1a may be determined by an exposure frequency of the artist data 1a. That is, the weight for the artist data 1a may be determined by the number of views and the number of watches for the artist data 1a.

The weight for the artist data 1a may have a specific numerical value. For example, when the exposure frequency of one artist data 1a is greater than the exposure frequency of another artist data 1a, the weight of the one artist data 1a may be determined to be higher than the weight of the other artist data 1a.

The weight calculated for each artist data 1a may be used to calculate the awareness and reputation of each group data 2.

The artist analysis module 1130 may include the awareness analysis unit 1133 that analyzes the awareness of each group data 2.

The awareness analyzed by the awareness analysis unit 1133 may be used as a measure for determining how much a specific artist is exposed to the public for a corresponding sub-field.

In addition, the artist analysis module 1130 may include the reputation analysis unit 1134 that analyzes the reputation of each group data 2.

The reputation analyzed by the reputation analysis unit 1134 may be used as a measure for determining how positive or negative reputation a specific artist has with the public for the corresponding sub-field.

The awareness and reputation of the group data 2 may be calculated as follows.

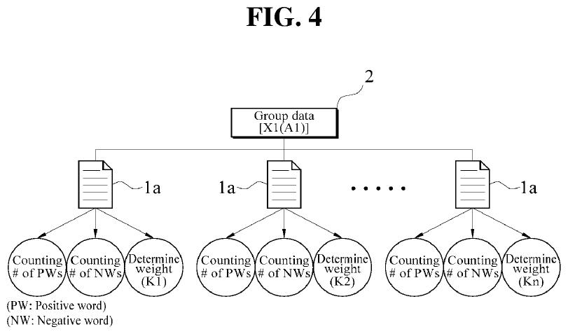

Referring to FIG. 4, group data [X1(A1)] among the group data 2 may include artist data 1a classified into a sub-field A1 among artist data 1a for the artist named X1.

The weight refers to the frequency with which the corresponding artist data 1a is exposed to the public, so that when the weights of all pieces of artist data 1a included in the group data [X1(A1)] are added up, it may be possible to identify the extent to which the artist named X1 has been exposed to the public for the sub-field A1.

Specifically, by adding up all of the weights of pieces of artist data 1a classified into the ballad-singer field among the artist data 1a for the artist X1, it is possible to identify how well-known the artist X1 is to the public as a ballad singer.

Therefore, when the number of pieces of artist data 1a included in any one group data 2 is ‘n’, an awareness level of the corresponding group data 2 may be calculated by summing all the weights of the ‘n’ pieces of artist data 1a. The awareness degree may be a factor having a specific numerical value.

In addition, each artist data 1a classified into the sub-field A1 may include positive words and negative words, and the number of positive words and negative words may be counted by the reputation analysis unit 1134 described above.

In an embodiment, the positive word may mean a keyword included in a preset positive keyword group, and the negative word may mean a keyword included in a preset negative keyword group.

For example, the positive word may include keywords such as best, good, fun, and the like or emoticons having a positive meaning. In addition, the negative word may include keywords such as worst, bad, boring, and the like, or emoticons having a negative meaning.

In an embodiment, positive words and negative words may be classified by a machine learning algorithm. For example, by allowing a separate learning device to learn classification criteria by continuously providing positive words and negative words to the learning device, the positive words and the negative words may be classified according to the learned classification criteria.

The reputation analysis unit 1134 may count the number of classified positive words and the number of classified negative words, and then add up the numbers.

In an embodiment, when five positive words and three negative words are included in any one artist data 1a, the reputation analysis unit 1134 may subtract the number of negative words from the number of positive words and then multiply a result of the subtraction and a weight to calculate a text reputation. The reputation may be a factor with a specific numerical value.

The text reputation may indicate whether the public's perception for the artist data 1a is positive or negative, and how much the perception has been exposed to the public.

Therefore, when the text reputations of all of pieces of artist data 1a belonging to any one group data 2 are summed up, it may be possible to indicate whether the public's perception for the sub-field of the corresponding group data 2 is positive or negative, and how much the perception has been exposed to the public. That is, the reputation for the sub-field of the corresponding group data 2 may be identified.

Through the above-described process, the artist analysis module 1130 may calculate the awareness and reputation for each group data 2.

Because the awareness and reputation for each sub-field may be calculated by the artist analysis module 1130, it may be known in which sub-field any one artist has high awareness and high reputation. Conversely, it may be known in which sub-field any one artist has low awareness and low reputation.

The calculated awareness and reputation may be used to determine top artists among a reference artist with respect to a comparative group (or comparative sub-field).

Referring back to FIG. 2, the comparative artist determining unit 110 may include the top artist determining module 1150.

In addition, the top artist determining module 1150 may include a reference artist determining unit 1151 that receives information on an artist to be used as a reference for comparison in the user interface module 1180.

In addition, the top artist determining module 1150 may include a comparative group determining unit 1152 that receives information on a comparative group (or a comparative sub-field) from the user interface module 1180.

When the information on the reference artist and the comparative sub-field is transmitted, a top artist determining unit 1153 may determine artists having higher values than the reference artist as top artists with respect to the awareness and reputation of the group data 2 for the comparative sub-field.

In an embodiment, when the user interface module 1180 sets an artist X1 as a reference artist and sets a ballad singer A1 as a comparative sub-field, artists having higher reputation and awareness than the reference artist for the ballad singer A1 are determined as the top artists.

At least one of the top artists may be determined as a comparative artist and used to calculate guide data.

The public's perception for an artist may be greatly influenced by the artist's appearance and personality shown in the mass media.

Therefore, when an artist most similar in appearance and personality to the reference artist among the top artists is set as a comparative artist, the utilization of the calculated guide data may be improved.

The appearance and personality of the artist may be analyzed by the matching element analysis module 1140.

The matching element analysis module 1140 may include an appearance analysis unit 1141 and a personality analysis unit 1142.

The appearance analysis unit 1141 may determine a type, such as the artist's gender, facial and body proportions, or the like by using the artist data 1a including an image or video associated with the artist.

In an embodiment, the database module 1170 may store a gender type classified according to preset criteria based on a face shape, a hair length, a face color, worn clothes, and the like.

The appearance analysis unit 1141 may determine the gender type of the artist by comparing the gender type with the artist data 1a including an image or video associated with the artist.

In an embodiment, the database module 1170 may store a face type classified according to preset criteria based on a forehead length, nose length and shape, eye length and width, lip width and length, lower jaw length, and their proportions.

The appearance analysis unit 1141 may determine a face type of the artist by comparing the face type with the artist data 1a including an image or video associated with the artist.

In an embodiment, the database module 1170 may store a body proportion types classified according to preset criteria based on arm length, leg length, neck length, head length, waist length, their proportions, or the like.

The appearance analysis unit 1141 may determine a body proportion type of the artist by comparing the body proportion type with the artist data 1a including an image or video associated with the artist.

Also, the personality analysis unit 1142 may determine a preset personality type using the artist data 1a.

In an embodiment, the preset personality type may be a Myers-Briggs Type Indicator (MBTI) personality type. The personality analysis unit 1142 may determine a personality type of the artist by using MBTI personality type information of the artist included in the artist data 1a. In addition, MBTI personality type information of a specific artist may be directly input through the user interface module 1180.

In an embodiment, the preset personality type may be classified into an extrovert type and an introvert type. The artist's personality type may be determined by establishing a keyword group representing an extroverted personality and a keyword group representing an introverted personality and determining the public's exposure to each of the keyword groups.

A method of determining the public's exposure for each keyword group may be performed similarly to the method of determining the awareness of the group data 2 as described above.

The comparative artist determining module 1160 may determine a comparative artist from the top artists. The comparative artist determining module 1160 may include a specified comparative artist determining unit 1161, a matching unit 1162, and a recommended comparative artist determining unit 1163.

The comparative artist may be determined based on information transmitted from the user interface module 1180 or an appearance type and a personality type determined by the matching element analysis module 1140.

First, the top artist determined by the top artist determining module 1150 may be transmitted to the user interface module 1180. The user may specify a specific artist among the top artists displayed on the user interface module 1180 as a comparative artist.

Information on the comparative artist specified by the user may be transmitted to the specified comparative artist determining unit 1161, and the specified comparative artist determining unit 1161 may determine a comparative artist according to the transmitted information.

Also, the matching unit 1162 may compare an appearance type and a personality type of the top artists with an appearance type and a personality type of the reference artist, and then determine an artist with an appearance type and a personality type most matching the appearance type and the personality type of the top artists.

The information on the determined artist may be transmitted to the recommended comparative artist determining unit 1163, and the recommended comparative artist determining unit 1163 may determine a comparative artist according to the transmitted information.

When the appearance type and the personality type of the comparative artist match those of and the reference artist, the utilization of guide data may be increased.

The database module 1170 may store information generated in each modules of the comparative artist determining unit 110 or provide reference information used for calculation of each module.

In one embodiment, the database module 1170 may include at least one type of storage medium among a flash memory type, a hard disk type, a multimedia card micro type, a card type memory (for example, SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), a magnetic memory, a magnetic disk, and an optical disk.

The user interface module 1180 may provide an interface capable of allowing a user to input data and receiving the data. The user may identify top artist information through the user interface module 1180 and input information on a reference artist and a comparative artist.

In addition, the user interface module 1180 may be electrically connected to the user terminal 200, and an interface provided to the user interface module 1180 may be provided to the user terminal 200 in the same manner.

In addition, the communication module 1190 may implement communication with external devices.

Information on the comparative artist determined by the comparative artist determining unit 110 may be transmitted to the guide data providing unit 120.

(2) Description of the Guide Data Providing Unit 120

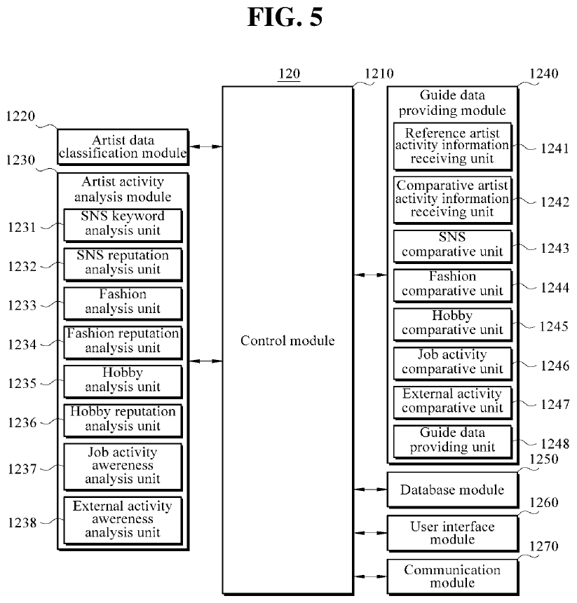

Referring to FIG. 5, the guide data providing unit 120 may include a control module 1210, an artist data classification module 1220, an artist activity analysis module 1230, a guide data providing module 1240, a database module 1250, a user interface module 1260 and a communication module 1270.

Various entities included in the guide data providing unit 120 may be electrically connected to one another. For example, communication between the entities may be performed through wired/wireless networks (not shown). For the wired/wireless networks, standard communication technologies and/or protocols may be used.

The hardware configuration of the guide data providing unit 120 may be implemented in various ways. For example, the artist data classification module 1220 and the artist activity analysis module 1230 may be integrated into a single component. However, the inventive concept is not limited thereto, and may be implemented in various methods and combinations.

The control module 1210 may control the artist data classification module 1220, the artist activity analysis module 1230, the guide data providing module 1240, the database module 1250, the user interface module 1260, and the communication module 1270 to perform various functions of the guide data providing unit 120.

The artist data classification module 1220 may classify artist data 1a for any one artist into SNS data 11a, fashion data 12a, hobby data 13a, job activity data 14a, and external activity data 15a.

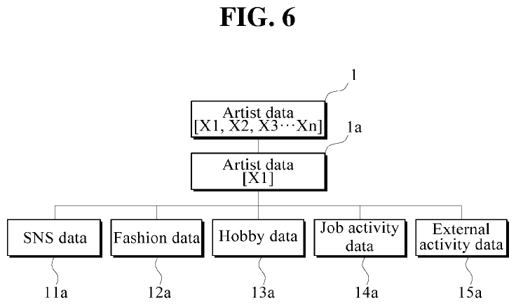

Referring to FIG. 6, the artist data 1a on an artist X1 may be classified into texts 11a, 12a, 13a, 14a and 15a.

In the illustrated embodiment, the SNS data 11a may refer to the artist data 1a collected from SNS (Social Network Service) such as Twitter, Facebook, and Instagram among the artist data 1a of the artist X1.

In the illustrated embodiment, the fashion data 12a may refer to the artist data 1a including keywords or images included in a preset fashion keyword group among the artist data 1a of the artist X1. For example, the fashion keyword group may include keywords or images such as product names and product numbers of brands.

In the illustrated embodiment, the hobby data 13a may refer to the artist data 1a including a keyword or an image included in a preset hobby keyword group among the artist data 1a of the artist X1. For example, the hobby keyword group may include keywords or images such as climbing, surfing, camping, soccer, basketball, shopping, and DIY.

In the illustrated embodiment, the job activity data 14a may refer to the artist data 1a including a keyword or an image included in a preset job activity keyword group among the artist data 1a of the artist X1. For example, the job activity keyword group may include keywords or images such as a music broadcast name, a preview, a runway, a fashion show name, and an entertainment/current affairs program name.

In the illustrated embodiment, the external activity data 15a may refer to the artist data 1a including a keyword or an image included in a preset job activity keyword group among the artist data 1a of the artist X1. For example, the external activity keyword group may include keywords or images such as service, donation, and politics.

Referring back to FIG. 5, the artist activity analysis module 1230 may include an SNS keyword analysis unit 1231, an SNS reputation analysis unit 1232, a fashion analysis unit 1233, a fashion reputation analysis unit 1234, a hobby analysis unit 1235, a hobby reputation analysis unit 1236, a job activity awareness analysis unit 1237, and an external activity awareness analysis unit 1238.

The SNS data 11a classified by the artist data classification module 1220 may be transmitted to the SNS keyword analysis unit 1231 and the SNS reputation analysis unit 1232.

The SNS keyword analysis unit 1231 may analyze SNS keywords including information on overlapping tones, words, images, and the like in the SNS data 11a.

In addition, the SNS reputation analysis unit 1232 may calculate SNS data reputations using the numbers of positive and negative words included in the SNS data 11a and weights, and then sum up all of the calculated SNS data reputations to calculate an SNS reputation.

The method of calculating the SNS reputation may be performed in a similar manner to the method of analyzing group data reputation in the artist analysis module 1130.

The fashion data 12a classified by the artist data classification module 1220 may be transmitted to the fashion analysis unit 1233 and the fashion reputation analysis unit 1234.

The fashion analysis unit 1233 may analyze fashion data including information on the most overlapping brand products, product names, clothing types, and the like in the fashion data 12a.

In addition, the fashion reputation analysis unit 1234 may calculate fashion data reputations using the numbers of positive and negative words included in the fashion data 12a and weights, and then sum up all of the calculated fashion data reputations to calculate the fashion reputation.

The method of calculating the fashion reputation may be performed in a similar manner to the method of analyzing group data reputation in the artist analysis module 1130.

The hobby data 13a classified by the artist data classification module 1220 may be transmitted to the hobby analysis unit 1235 and the hobby reputation analysis unit 1236.

The hobby analysis unit 1235 may analyze hobby data, which is information on most overlapping keywords in the hobby data 13a.

In addition, the hobby reputation analysis unit 1236 may calculate hobby data reputations using the numbers of positive and negative words included in the hobby data 13a and weights, and then sum up all of the calculated fashion data reputations to calculate the hobby reputation.

The method of calculating the hobby reputation may be performed in a similar manner to the method of analyzing group data reputation in the artist analysis module 1130.

The job activity data 14a classified by the artist data classification module 1220 may be transmitted to the job activity awareness analysis unit 1237.

The job activity awareness analysis unit 1237 may analyze job activity awareness by summing up weights of the job activity data 14a.

The method of analyzing the job activity awareness may be performed in a similar manner to the method of analyzing group data awareness in the artist analysis module 1130.

The external activity data 15a classified by the artist data classification module 1220 may be transmitted to the external activity awareness analysis unit 1238.

The external activity awareness analysis unit 1238 may analyze the external activity awareness by summing up the weights of the external activity data 15a.

The method of analyzing the external activity awareness may be performed in a similar manner to the method of analyzing group data awareness in the artist analysis module 1130.

The SNS keywords, SNS reputation, fashion data, fashion reputation, hobby data, hobby reputation, job activity awareness, and external activity awareness analyzed by the artist activity analysis module 1230 may be transmitted to the guide data providing module 1240.

The guide data providing module 1240 may include a reference artist activity information receiving unit 1241 and a comparative artist activity information receiving unit 1242.

The guide data providing module 1240 may receive information on the reference artist and the comparative artist from the comparative artist determining unit 110.

The reference artist activity information receiving unit 1241 may receive an SNS keyword, SNS reputation, fashion data, fashion reputation, hobby data, hobby reputation, job activity awareness and external activity awareness for the reference artist among the information received from the artist activity analysis module 1230.

The comparative artist activity information receiving unit 1242 may receive an SNS keyword, SNS reputation, fashion data, fashion reputation, hobby data, hobby reputation, job activity awareness and external activity awareness for the comparative artist among the information received from the artist activity analysis module 1230.

In addition, the guide data providing module 1240 may include an SNS comparison unit 1243, a fashion comparison unit 1244, a hobby comparison unit 1245, a job activity comparison unit 1246, and an external activity comparison unit 1247.

The SNS comparison unit 1243 calculates SNS comparison data including information about the difference in SNS keywords and the difference in SNS reputation between the reference artist and the comparative artist.

The fashion comparison unit 1244 may calculate fashion comparison data including information on difference in fashion data and difference in fashion reputation between the reference artist and the comparative artist.

The hobby comparison unit 1245 may calculate hobby comparison data including information on a difference in hobby data and a difference in hobby reputation between the reference artist and the comparative artist.

The job activity comparison unit 1246 may calculate job activity comparison data including information on a difference in job activity awareness between the reference artist and the comparative artist.

The external activity comparison unit 1247 may calculate external activity comparison data including information on a difference in external activity awareness between the reference artist and the comparative artist.

Also, the guide data providing module 1240 may include a guide data providing unit 1248.

The guide data providing unit 1248 may calculate guide data including all of the calculated SNS comparison data, fashion comparison data, hobby comparison data, job activity comparison data, and external activity comparison data.

The guide data may be displayed as information in a form that is visually recognizable on the user interface module 1260 or the user terminal 200 and provided to the user.

The database module 1250 may store information generated by each module of the guide data providing unit 120 or provide reference information used for calculation of each module.

In one embodiment, the database module 1250 may include at least one type of storage medium among a flash memory type, a hard disk type, a multimedia card micro type, a card type memory (for example, SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), a magnetic memory, a magnetic disk, and an optical disk.

The user interface module 1260 may provide an interface for receiving data from a user. The user may identify guide data through the user interface module 1260.

In addition, the user interface module 1260 may be electrically connected to the user terminal 200, and an interface provided to the user interface module 1260 may be provided to the user terminal 200 in the same manner.

In addition, the communication module 1270 may implement communication with external devices.

According to the guide information providing system according to the present embodiment, the following effects may be derived.

According to the present embodiment, after classifying the field in which an artist works into sub-fields by subdividing the field, the awareness and reputation recognized for a specific artist with respect to each sub-field by the public may be derived.

For example, when the main field in which the artist X1 works is a ballad singer who sings ballad songs, it is possible to identify how well the artist X1 is known to the public in the ballad singer field as a numerical value (awareness).

In addition, it is possible to identify whether the artist X1 is perceived positively or negatively by the public, and when the artist X1 is perceived positively, to what extent the artist X1 is perceived positively (reputation) as a numerical value.

When it is wanted to increase the reputation recognized by the public in the ballad-singer field, which is the main field of the artist X1, information on other artists who have higher awareness and reputation than the artist X1 in the ballad singer the field may be received.

For example, it may be possible to receive the public's reputation on keywords frequently used on SNS and SNS posts posted by other artists with higher awareness and reputation in the ballad singer field.

When another artist's SNS posts have a higher reputation than the SNS posts of the artist X1, the artist X1 may use keywords frequently used by the another artist on his or her SNS posts for the SNS posts of the artist X1.

In addition, for example, daily fashion of other artists with higher recognition and reputation in the ballad singer field, the public's reputation on the daily fashion and the like may be provided.

When the fashion of another artist has higher reputation than that of the fashion of the artist X1, the artist X1 may try to use brands and brand products that another artist often wears.

That is, when a specific artist wants to increase awareness and reputation in her or his main field, the specific artist may obtain guide data, which is information obtained by comparing various information of other artists with those of the specific artist, the other artists having higher recognition and reputation than the specific artist itself in the corresponding field.

The above specific artist may utilize the obtained guide data to improve her or his awareness and reputation in her or his main field.

In addition, even when a specific artist wants to increase public awareness and reputation for a new field in which the specific artist wants to break new ground, not in her or his main field, the specific artist may obtain guide data for other artists who have a higher awareness and reputation than those of the specific artist in the field in which the specific artist wants to break new ground.

In addition, because the public's perception on artists is greatly affected by the artists' appearance and personality, an artist with the most similar appearance and personality may be selected in selecting an artist to be compared.

The guide data for artists with the most similar appearance and personality may be provided, thus improving the utilization of the guide data.

For example, when the appearance of the artist to be compared is similar to the appearance of an artist who intends to use the guide data, the utilization of fashion information may be increased.

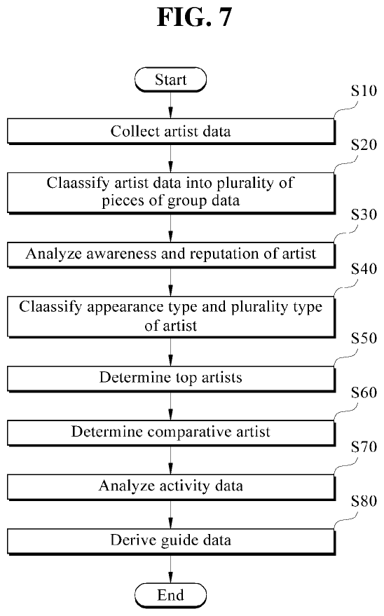

Hereinafter, an operation process of a guide information providing system according to the present embodiment will be described with reference to FIGS. 7 to 9.

2. Description of the operation process of a guide information providing system for enhancement of an artist's reputation according to an embodiment of the inventive concept

Description of Operation of Collecting Artist Data 1 (S10)

First, artist data 1 may be collected by the original data generating device 300. The original data generating device 300 may collect artist data 1a including information on a specific artist, and create entire artist data 1 by collecting pieces of artist data 1a collected for artists.

(2) Description of Operation of Classifying Pieces of Artist Data 1a into a Plurality of Pieces of Group Data 2 (S20)

Each group data 2 may include a keyword group, which is a set of keywords capable of representing a sub-field, and the artist data 1a including a keyword belonging to each keyword group may be classified and included in the corresponding group data 2.

Classification of the artist data 1a may be performed by the field-based grouping unit 1131. Because the grouping unit 1131 has been described above, a specific performance process of classifying the artist data 1a may be understood with reference to the description of the grouping unit 1131.

Also, a weight of each artist data 1a may be determined by the weight determining unit 1132.

Because the weight determining unit 1132 has been described above, a specific performance process of determining the weight may be understood with reference to the description of the weight determining unit 1132.

(3) Description of Operation of Analyzing Awareness and Reputation of an Artist (S30)

Awareness and reputation may be analyzed for each group data classified in S20.

The awareness of each group data 2 may be calculated by the awareness analysis unit 1133, and the reputation of each group data 2 may be calculated by the reputation analysis unit 1134.

Because the awareness analysis unit 1133 and the reputation analysis unit 1134 have been described above, the specific performance process of calculating the awareness and reputation of the group data 2 may be understood with reference to description of the awareness analysis unit 1133 and the reputation analysis unit 1134.

(4) Description of the Step (S40) of Classifying the Artist's Appearance Type and Personality Type

An appearance types and a personality type may be analyzed for each artist by the matching element analysis module 1140.

Specifically, the appearance type for each artist may be determined by the appearance analysis unit 1141, and the personality type for each artist may be determined by the personality analysis unit 1142.

Because the appearance analysis unit 1141 and the personality analysis unit 1142 have been described above, the specific performance process of determining the appearance type and the personality type may be understood with reference to the description of the appearance analysis unit 1141 and the personality analysis unit 1142.

(5) Description of Operation of Determining Top Artists (S50)

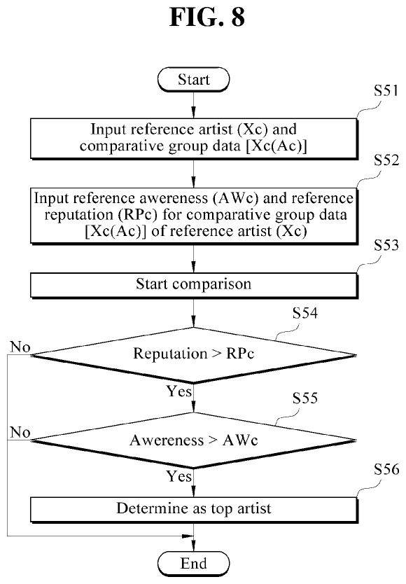

Referring to FIG. 8, information on a reference artist Xc and comparative group data [Xc(Ac)] may be transmitted from the user interface module 1180 to the top artist determining module 1150.

For example, information indicating that an artist named X1 is specified as the reference artist Xc and information indicating that group data 2 for the ballad-singer (A1) field among subfields is determined as the comparative group data [Xc(Ac)] may be input (S51).

Then, reference awareness AWc and reference reputation RPc of the reference artist Xc for the comparative group data [Xc(Ac)] may be transmitted from the artist analysis module 1130 to the top artist determining module 1150 (S52).

When the reference awareness AWc and the reference reputation RPc are transmitted, the top artist determining module 1150 may compare the awareness and reputation of other artists with respect to the comparative group data with the reference awareness AWc and the reference reputation RPc (S53).

When the reputation of any one artist with respect to the comparative group data is less than or equal to the reference reputation RPc, the corresponding artist may not be selected as a top artist (S54).

When the reputation of any one artist with respect to the comparative group data is higher than the reference reputation RPc, the recognition awareness of the one artist with respect to the comparative group data may be compared with the reference awareness AWc (S55).

When the awareness of any one artist with respect to the comparative group data is less than or equal to the reference awareness AWc, the corresponding artist may not be selected as the top artist (S55).

When the awareness of any one artist with respect to the comparative group data is higher than the reference awareness AWc, the corresponding artist may be determined as the top artist (S56).

(6) Description of Operation of Determining a Comparative Artist (S60)

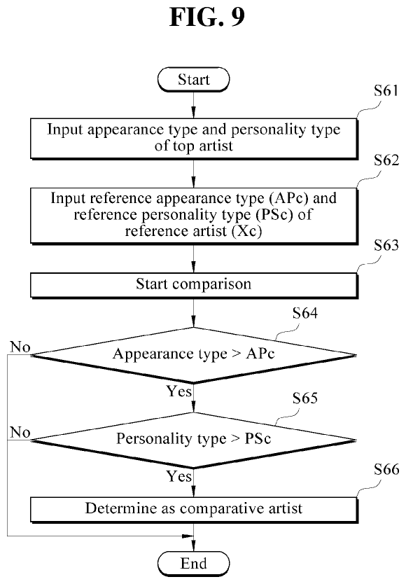

Referring to FIG. 9, information on a top artist may be transmitted from the top artist determining module 1150 to the comparative artist determining module 1160.

In addition, information on the appearance type and the personality type of the top artist may be transmitted from the matching element analysis module 1140 to the comparative artist determining module 1160 (S61), and information on a reference appearance type APc and reference personality type PSc of the reference artist Xc may be transmitted (S62).

The comparative artist determining module 1160 may compare the reference artist with the top artist with respect to the transmitted appearance type and the transmitted personality type (S63).

When the appearance type of any one of the top artists does not match the reference appearance type APc, the corresponding artist may not be selected as a comparative artist (S64).

When the appearance type of the one artist matches the reference appearance type APc, the personality type of the one artist may be compared with the reference personality type PSc (S65).

When the personality type of the one artist does not match the reference personality type PSc, the corresponding artist may not be selected as a comparative artist (S65).

When the personality type of the one artist matches the reference personality type PSc, the corresponding artist may be determined as a comparative artist (S66).

(7) Description of Operation of Analyzing Activity Data (S70)

The artist activity analysis module 1230 may receive SNS data 11a, fashion data 12a, hobby data 13a, job activity data 14a, and external activity data 15a from the artist data classification module 1220 and analyze activity data of the artist.

The activity data may include SNS keywords, SNS reputation, fashion data, fashion reputation, hobby data, hobby reputation, job activity awareness, and external activity awareness.

Because the artist activity analysis module 1230 has been described above, a specific process of analyzing activity data may be understood with reference to the description of the artist activity analysis module 1230.

(8) Operation of Deriving Guide Data (S80)

The guide data providing module 1240 may receive activity data of the reference artist and the comparative artist and calculate guide data.

The calculated guide data may be provided as information in a form that is visually recognizable to the user through the user interface module 1260 or the user terminal 200.

Because the guide data providing module 1240 has been described above, a specific process of calculating the guide data may be understood with reference to the description of the guide data providing module 1240.

The steps of a method or algorithm described in connection with the embodiments of the present disclosure may be implemented directly in hardware, in a software module executed by hardware, or in a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or in a computer readable recording medium that is well known in the art.

Although embodiments of the present disclosure have been described above with reference to the accompanying drawings, it is understood that those skilled in the art to which the present disclosure pertains may implement the present disclosure in other specific forms without changing the technical spirit or essential features thereof. Therefore, it should be understood that the embodiments described above are illustrative in all respects and not restrictive.

According to an embodiment of the inventive concept, it is possible to provide guide information that may help to positively form an artist's reputation in an artist's main field or a field in which the artist intends to break new ground.

Thereby, it is possible to reduce the cost and time required for the artist or the artist's agency to positively form the artist's reputation by providing guide information.

Effects of the inventive concept may not be limited to the above-described effects. Although not described herein, other effects to be solved by the inventive concept can be clearly understood by those skilled in the art from the following description.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A guide information providing device for improvement of an artist's reputation, comprising
an artist data collection module configured to collect artist data including at least one of a text, a video, and an image as data obtained by searching for an artist;
an artist analysis module configured to group the artist data by a plurality of different fields, classify the artist data into a plurality of pieces of group data, and analyze awareness and reputation using each of the pieces of group data;
a matching element analysis module configured to classify an appearance type and a personality type using the artist data;
a top artist determining module configured to determine at least one top artist having a higher value than a preset reference artist, with respect to the awareness and the reputation associated with at least one of the pieces of group data;
a comparative artist determining module configured to specify any one of the top artists as a comparative artist, or specify an artist having an appearance type and a personality type matching those of the reference artist as the comparative artist;
an artist activity analysis module configured to analyze activity data on the artist using the artist data; and
a comparative data providing module configured to derive comparative data using the activity data of the reference artist and the comparative artist, and provide the comparative data to a user.

2. The guide information providing device of claim 1, wherein each of the pieces of group data includes a preset keyword group for each field,
wherein the artist analysis module includes
a field-based grouping unit configured to classify the artist data including the preset keyword group into the group data corresponding to the preset keyword group;
a weight determining unit configured to calculate a weight for the artist data by analyzing an exposure frequency of the artist data;
an awareness analysis unit configured to calculate an awareness for each of the pieces of group data by summing up all weights of pieces of artist data included in each of the group data; and
a reputation analysis unit configured to calculate the reputation for each of the pieces of group data using positive words, negative words, and weights of the artist data included in each of the group data,
wherein the reputation for each of the group data is calculated by calculating text reputations for the pieces of artist data in a manner to subtract a number of the negative words from a number of the positive words and multiply a result of the subtraction and the weight for each of the pieces of artist data and then summing up all the text reputations included in the group data.

3. The guide information providing device of claim 2, wherein the appearance type includes a preset face type and a preset body proportion type,
wherein the personality type includes an MBTI type or a preset standard personality type,
wherein the matching element analysis module includes
an appearance analysis unit configured to determine the face type by using a forehead length, a nose length, an eye length and width, a lip length, a lower jaw proportion and determine the body proportion type using lengths of body parts and a proportion of the body parts; and
a personality analysis unit configured to determine the MBTI type or the standard personality type.

4. The guide information providing device of claim 3, wherein the top artist determining module includes
a reference artist determining unit configured to determine the reference artist;
a comparative group determining unit configured to determine comparative group data that is data to be compared among the plurality of pieces of group data; and
a top artist determining unit configured to determine at least one top artist having a higher value than the preset reference artist, with respect to the awareness and reputation associated with the comparative group data.

5. The guide information providing device of claim 4, wherein the comparative artist determining module includes
a specified comparative artist determining unit configured to determine any one of the top artists as a comparative artist; and
a recommended artist determining unit configured to determine an artist having an appearance type and a personality type matching those of the reference artist among the top artists as the comparative artist.

6. The guide information providing device of claim 5, wherein the artist data includes
artist SNS data obtained by searching for an artist's SNS;
fashion data including the artist's reputation;
hobby data including a hobby keyword included in a preset hobby keyword group;
job activity data including a job activity keyword included in a preset job activity keyword group; and
external activity data including an external activity keyword included in a preset external activity keyword group,
wherein the artist activity analysis module includes
an SNS keyword analysis unit configured to analyze an SNS keyword that is an overlapping keyword by using the artist SNS data;
an SNS reputation analysis unit configured to calculate SNS reputation by using the artist SNS data;
a fashion analysis unit configured to analyze fashion type information that is information including a clothing type, products, and brands mainly worn by the artist by using the fashion data;
a fashion reputation analysis unit configured to calculate fashion reputation by using the fashion data;
a hobby analysis unit configured to analyze hobby data that is information on a most overlapping keyword among the hobby keywords included in the hobby data;
a hobby reputation analysis unit configured to calculate hobby reputation by using the hobby data;
a job activity awareness analysis unit configured to calculate job activity awareness by summing up weights of the job activity data; and
an external activity awareness analysis unit configured to calculate external activity awareness by summing up weights of the external activity data,
wherein the activity data includes the SNS keyword, the SNS reputation, the fashion type information, the fashion reputation, the hobby data, the hobby reputation, the job activity awareness, and the external activity awareness.

7. The guide information providing device of claim 6, wherein the comparative data providing module is configured to:
receive activity data of the reference artist and activity data of the comparative artist; and
match the reference artist and the comparative artist with respect to the SNS keyword, the SNS reputation, the fashion type information, the fashion reputation, the hobby data, the hobby reputation, the job activity awareness, and the external activity awareness and provide a result of the matching to the user.

8. A guide information providing method for improvement of an artist's reputation, the method being performed by a device, comprising
collecting, by an artist data collection module of the device, artist data including at least one of a text, a video, and an image as data obtained by searching for an artist;
grouping, by an artist analysis module of the device, the artist data by a plurality of different fields, classify the artist data into a plurality of pieces of group data, and analyze awareness and reputation using each of the pieces of group data;
classifying, by a matching element analysis module of the device, an appearance type and a personality type using the artist data;
determining, by a top artist determining module of the device, at least one top artist having a higher value than a preset reference artist, with respect to the awareness and the reputation associated with at least one of the pieces of group data;
specifying, by a comparative artist determining module of the device, any one of the top artists as a comparative artist, or specify an artist having an appearance type and a personality type matching those of the reference artist as the comparative artist;
analyzing, by an artist activity analysis module of the device, activity data on the artist using the artist data; and
deriving, by a comparative data providing module of the device, comparative data using the activity data of the reference artist and the comparative artist, and provide the comparative data to a user.

9. The guide information providing method of claim 8, wherein each of the pieces of group data includes a preset keyword group for each field,
wherein the artist analysis module includes
a field-based grouping unit configured to classify the artist data including the preset keyword group into the group data corresponding to the preset keyword group;
a weight determining unit configured to calculate a weight for the artist data by analyzing an exposure frequency of the artist data;
an awareness analysis unit configured to calculate an awareness for each of the pieces of group data by summing up all weights of pieces of artist data included in each of the group data; and
a reputation analysis unit configured to calculate the reputation for each of the pieces of group data using positive words, negative words, and weights of the artist data included in each of the group data,
wherein the reputation for each of the group data is calculated by calculating text reputations for the pieces of artist data in a manner to subtract a number of the negative words from a number of the positive words and multiply a result of the subtraction and the weight for each of the pieces of artist data and then summing up all the text reputations included in the group data.

10. The guide information providing method of claim 9, wherein the appearance type includes a preset face type and a preset body proportion type,
wherein the personality type includes an MBTI type or a preset standard personality type,
wherein the matching element analysis module includes
an appearance analysis unit configured to determine the face type by using a forehead length, a nose length, an eye length and width, a lip length, a lower jaw proportion and determine the body proportion type using lengths of body parts and a proportion of the body parts; and
a personality analysis unit configured to determine the MBTI type or the standard personality type.

11. The guide information providing method of claim 10, wherein the top artist determining module includes
a reference artist determining unit configured to determine the reference artist;
a comparative group determining unit configured to determine comparative group data that is data to be compared among the plurality of pieces of group data; and
a top artist determining unit configured to determine at least one top artist having a higher value than the preset reference artist, with respect to the awareness and reputation associated with the comparative group data.

12. The guide information providing method of claim 11, wherein the comparative artist determining module includes
a specified comparative artist determining unit configured to determine any one of the top artists as a comparative artist; and
a recommended artist determining unit configured to determine an artist having an appearance type and a personality type matching those of the reference artist among the top artists as a comparative artist.

13. The guide information providing method of claim 12, wherein the artist data includes
artist SNS data obtained by searching for an artist's SNS;
fashion data including the artist's reputation;
hobby data including a hobby keyword included in a preset hobby keyword group;
job activity data including a job activity keyword included in a preset job activity keyword group; and
external activity data including an external activity keyword included in a preset external activity keyword group,
wherein the artist activity analysis module includes
an SNS keyword analysis unit configured to analyze an SNS keyword that is an overlapping keyword by using the artist SNS data;
an SNS reputation analysis unit configured to calculate SNS reputation by using the artist SNS data;
a fashion analysis unit configured to analyze fashion type information that is information including a clothing type, products, and brands mainly worn by the artist by using the fashion data;
a fashion reputation analysis unit configured to calculate fashion reputation by using the fashion data;
a hobby analysis unit configured to analyze hobby data that is information on a most overlapping keyword among the hobby keywords included in the hobby data;
a hobby reputation analysis unit configured to calculate hobby reputation by using the hobby data;
a job activity awareness analysis unit configured to calculate job activity awareness by summing up weights of the job activity data; and
an external activity awareness analysis unit configured to calculate external activity awareness by summing up weights of the external activity data,
wherein the activity data includes the SNS keyword, the SNS reputation, the fashion type information, the fashion reputation, the hobby data, the hobby reputation, the job activity awareness, and the external activity awareness.

14. The guide information providing method of claim 13, wherein the comparative data providing module is configured to
receive activity data of the reference artist and activity data of the comparative artist; and
match the reference artist and the comparative artist with respect to the SNS keyword, the SNS reputation, the fashion type information, the fashion reputation, the hobby data, the hobby reputation, the job activity awareness, and the external activity awareness and provide a result of the matching to the user.
